(19) United States
(12) Patent Application Publication
(10) Pub. No.: US 2004/0257603 A1
(43) Pub. Date: Dec. 23, 2004

(54) Print reception apparatus

(76) Inventors: Koji Nakamura, Tokyo (JP); Tadashi Suzuki, Tokyo (JP)

Correspondence Address: BIRCH STEWART KOLASCH & BIRCH, PO BOX 747, FALLS CHURCH, VA, 22040-0747, US

(21) Appl. No.: 10/868,828

(22) Filed: Jun. 17, 2004

(30) Foreign Application Priority Data
Jun. 20, 2003 (JP) 2003-176537

(51) Int. Cl. G06K 15/02; G06F 15/00; H04N 1/387; G06F 3/12

(52) U.S. Cl. 358/1.13; 358/1.16; 358/450; 358/527; 358/1.18

(57) ABSTRACT

The present invention is a print reception apparatus comprising a medium reader which a medium is detached from and attached to, a display device which displays various kinds of screens, an operation device, and a control device which makes the display device switch and display a screen on the basis of the detaching or attaching operation of the medium to or from the media reader and operation with the operation device, and generates ordering information while capturing images used for printing from the medium which is loaded in the media reader, wherein the control device controls a printer so as to print the captured images by two images on one sheet of photo paper.

### BACKGROUND OF THE INVENTION

1. Field of the Invention

The present invention relates to a print reception apparatus, and in particular, to a print reception apparatus which is installed in a shop front, inside of a shop, or the like, reads images, recorded in a medium, from the media for a portable telephone which a user brings, and performs printing.

2. Description of the Related Art

Up to now, there have been DSC reception service machines which each read data (image data and attendant information data necessary for an order) from a medium (SmartMedia card, XD picture card, CompactFlash card, SD card, memory stick, ATA PC card, floppy disk, etc.) used for a digital still camera (hereafter, “DSC”) and receives an order of printing, etc. In this kind of DSC reception service machine, various kinds of proposals from which optimum print images are obtained are made by the present applicant et al. (for example, refer to Japanese Patent Application Publication No. 2001-36843).

In addition, in recent years, portable telephones each having an image pickup function have been spreading quickly, and needs of printing images taken with these portable telephones on photo paper have been also increasing.

### SUMMARY OF THE INVENTION

However, it is common that an image taken with a portable telephone having an image pickup function is inferior to an image taken with a normal DSC in image quality, that is, a pixel count is small. Therefore, there arises a problem that, when the image taken with a portable telephone is printed in the same size (generally, L size) as the image taken with the normal DSC, a printed image is coarse and becomes unsightly.

On the other hand, plenty of portable telephones each having an image pickup function also have a switching function making it possible to take an image in the same image quality as a normal DSC. This switching function is seldom known by users. Nevertheless, when an image is taken in the same image quality as a normal DSC by the switch function, there does not arise the problem that a printed image is coarse and becomes unsightly even if it is printed in the same size as the image taken with the normal DSC.

Thus, when an image taken with a portable telephone which has an image pickup function is printed, it is required to select optimum print conditions according to the taken image. Nevertheless, a print reception apparatus which can respond to such a request finely by a simple operation has not been known up to now.

The present invention was made in view of such situation, and aims at providing a print reception apparatus whose operation is easy, i.e., user-friendly, and with which optimum image quality can be obtained when an image taken with a portable telephone is printed.

In order to attain the above-mentioned object, a first aspect of the present invention provides a print reception apparatus which is installed in a shop front or inside of a shop, reads images recorded in a medium of a portable telephone which a user brings, and accepts a printing order of the images, comprising a media reader which the medium is detached from and attached to, a display device which displays a screen for prompting an operation and verification of a user at the time of a printing order, an operation device which a user operating with looking at a screen displayed on the display device, a control device which makes the display device switch and display a screen on the basis of the detaching or attaching operation of the medium to or from the media reader and the operation with the operation device, and generates ordering information while capturing images used for printing from the medium which is loaded in the media reader, wherein the control device controls a printer so as to print the captured images by two images on one sheet of photo paper.

According to the first aspect of the present invention, it is possible to obtain an advantageous effect that optimum image quality is obtained when printing an image taken with a portable telephone. That is, as mentioned above, it is common that an image taken with a portable telephone has a pixel count smaller than an image taken with a normal DSC. Therefore, there arises a problem that, when the image taken with a portable telephone is printed in usual size (generally, L size), a printed image is coarse and becomes unsightly. However, when printing the image taken with a portable telephone by two images on one sheet of photo paper (generally photo paper in L size), not only there does not arise the problem that an image is coarse and becomes unsightly, but also it is possible to obtain advantageous effects that photo paper cost, print expenses, etc. are cut in half.

In addition, it is possible to raise the charm of a product itself since this becomes in convenient size of carrying photo paper with putting photo paper into a card case etc. when cutting off the printed portion of photo paper, and it is possible to write various information in margins.

A second aspect of the present invention provides a print reception apparatus which is installed in a shop front or inside of a shop, reads images recorded in a medium of a portable telephone which a user brings, and accepts a printing order of the images, comprising a media reader which the medium is detached from and attached to, a display device which displays a screen for prompting the operation and verification of a user at the time of a printing order, an operation device which a user operating with looking at a screen displayed on the display device, and a control device which makes the display device switch and display a screen on the basis of the detaching or attaching operation of the medium to or from the media reader and the operation with the operation device, and generates ordering information while capturing images used for printing from the medium which is loaded in the media reader, wherein the control device controls a printer so as to print the captured images by four images on one sheet of photo paper.

According to the second aspect of the present invention, similarly to the first aspect, there does not arise the problem that an image is coarse and becomes unsightly. In addition, it is possible to obtain the advantageous effect that photo paper cost, print expense, etc. are cut greatly.

As a third aspect of the present invention, it is preferable in the first and second aspects of the present invention that the control device comprises an image discrimination device discriminating pixel counts of the captured images while capturing the images, used for printing, from the medium which is loaded in the media reader, and that the control device makes the display device display a screen of print services suitable for a pixel count of each of the images.

Thus, when discriminating a pixel count of each image by the image discrimination device, it is possible to propose the print size corresponding to the pixel count. For example, even if it is an image taken with a portable telephone, there is also an image taken in the same image quality as that with a normal DSC. If the high quality image taken with a portable telephone is printed with the same print size as the image taken with the normal portable telephone, taking image quality can not be exhibited effectively, and hence, it is not preferable. Even in such a case, so long as the print size suitable for the taken image is proposed, it becomes user-friendly.

As a fourth aspect of the present invention, it is preferable in the first to third aspects of the present invention that the control device controls a printer so as to print attached information of an image near the image printed on a photo paper while capturing the attached information of the image, used for printing, from a medium which is mounted in the media reader.

When printing an image with a normal DSC, only a date or the like is printed as attached information. However, in portable telephones unlike DSC, there are many models which each can edit a file name, a title name, etc. Therefore, it becomes important that a file name etc. is printed in full size and that all characters are printed even if being a long file name. Thus, so long as the attached information of an image is printed near the image printed on photo paper, it is possible to obtain an advantageous effect that a utility value of the image taken with the portable telephone improves.

As a fifth aspect of the present invention, it is preferable in the third and fourth aspects of the present invention that the control device gives display, corresponding to a pixel count of an image, to the image, which is displayed in a thumbnail mode, while making the display device display the captured images in the thumbnail mode.

Thus, when the thumbnail display of the captured images is given, and further, the display corresponding to the pixel counts of the individual images is performed, it is convenient for a user to select the size of images to be printed.

As explained above, according to the first aspect of the present invention, it is possible to obtain optimum image quality when printing an image taken with a portable telephone. That is, as mentioned above, since it is common that an image taken with a portable telephone has a pixel count smaller than an image taken by a normal DSC, there arises a problem that, when this is printed in usual size (generally, L size), a printed image is coarse and becomes unsightly. However, when printing the image having a small pixel count by two images on one sheet of photo paper (generally, photo paper in L size), not only there does not arise the problem that an image is coarse and becomes unsightly, but also it is possible to obtain advantageous effects that photo paper cost, print expenses, etc. are cut in half.

According to the second aspect of the present invention, similarly to the first aspect, there does not arise the problem that an image is coarse and becomes unsightly. In addition, it is possible to obtain the advantageous effect that photo paper cost, print expense, etc. are cut greatly.

### BRIEF DESCRIPTION OF THE DRAWINGS

FIG. 1 is a schematic structural diagram showing an embodiment of a print reception apparatus (print reception service machine) according to the present invention;

FIG. 2 is a block diagram showing a hardware configuration example of a main body (PC) of the print reception service machine;

FIG. 3 is a schematic diagram of the software configuration in the main body;

FIG. 4 is a block diagram showing a configuration example of a media reader/writer of the print reception service machine;

FIG. 5 is a flowchart showing an embodiment using the print reception service machine;

FIG. 6 includes a screen shot showing an embodiment using the print reception service machine;

FIG. 7 includes a screen shot showing an embodiment using the print reception service machine;

FIG. 8 includes a screen shot showing an embodiment using the print reception service machine;

FIG. 9 includes screen shots showing an embodiment using the print reception service machine;

FIG. 10 includes a screen shot showing an embodiment using the print reception service machine;

FIG. 11 includes a screen shot showing an embodiment using the print reception service machine;

FIG. 12 includes screen shots showing an embodiment using the print reception service machine; and

FIG. 13A and FIG. 13B show schematic diagrams for explaining a function of selecting a printing location.

### DETAILED DESCRIPTION OF THE PREFERRED EMBODIMENTS

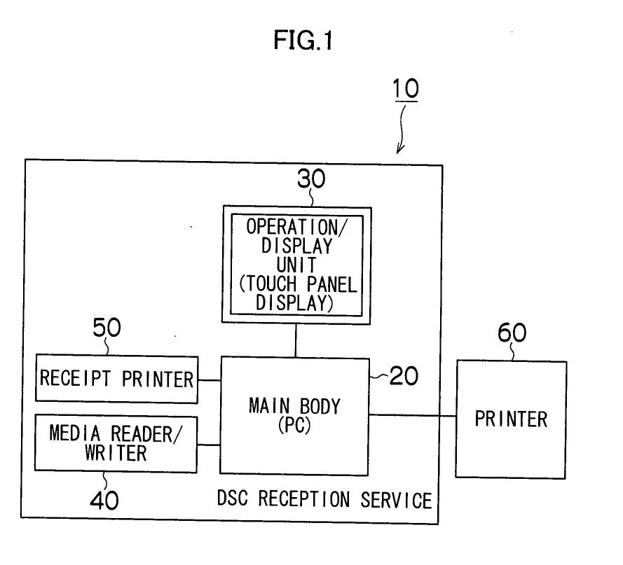

Preferable embodiments of a print reception apparatus according to the present invention will be described below in detail according to accompanying drawings. FIG. 1 is a schematic structural diagram showing an embodiment of the print reception apparatus (print reception service machine) according to the present invention.

As shown in FIG. 1, a print reception service machine 10 is installed in a shop front, the inside of a shop, or the like, reads information (image data), recorded in a medium, from the DSC medium which a user brings, and performs print service based on the image data. It mainly comprises a main body 20 such as a personal computer (PC), and a CRT display unit 30 (this corresponds to a display unit and a control unit) with a touch panel, a media reader/writer 40, and a receipt printer 50, as peripheral devices connected to the main body 20.

In addition, a printer 60 is connected to the print reception service machine 10. Furthermore, it is possible to install the printer 60 in a location other than an installation site of the print reception service machine 10 by connecting the printer 60 via a local area network (LAN) etc.

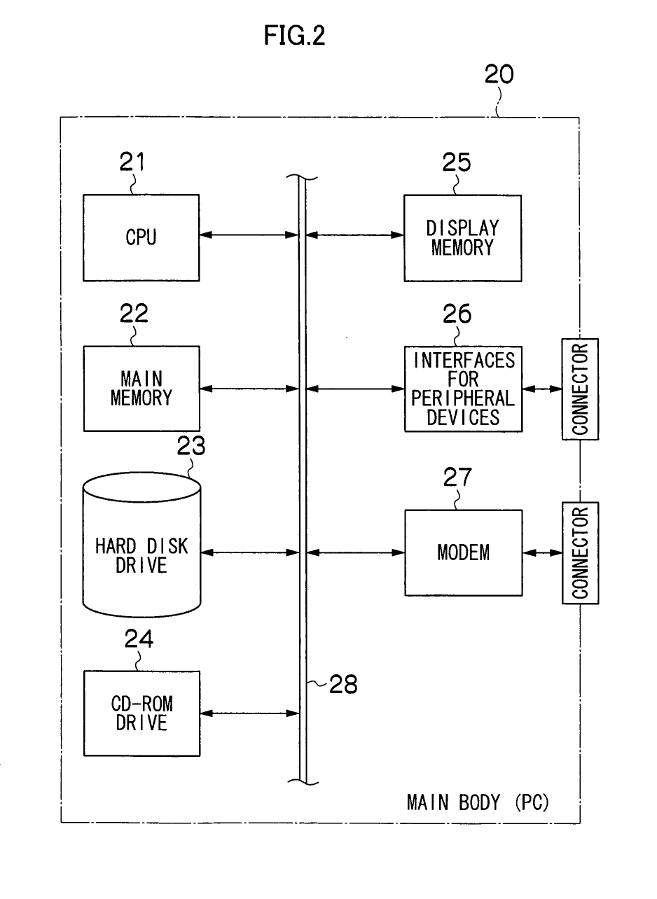

FIG. 2 is a block diagram showing a hardware configuration example of the main body 20. As shown in FIG. 2, the main body 20 comprises a central processing unit (CPU) 21 which mainly controls the operation of each component, main memory 22 which stores a control program of the apparatus and becomes a working area at the time of program execution, a hard disk drive 23 which stores an operating system (OS) such as Windows, device drivers of peripheral devices connected to the main body 20, various kinds of application software containing print reception service software, a user's images, and the like, a CD-ROM drive 24, display memory 25 which temporarily stores display data, interfaces 26 for peripheral devices (display unit I/F, touch panel I/F, USB (Universal Serial Bus), etc.), a modem 27, and a bus 28 which connects above-mentioned respective components.

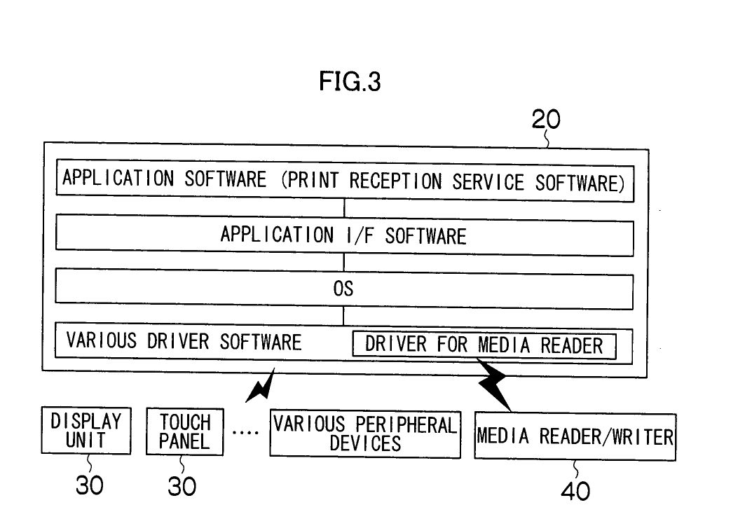

FIG. 3 is a schematic diagram of the software configuration in the main body 20. The main body 20 can build various systems efficiently by incorporating application software such as a print reception service software by using various interfaces (including driver software) under the management of the OS. In the case of the print reception service machine 10, a print reception service software is built in the main body 20 as application software.

The print reception service software communicates with the OS through application I/F software as shown in FIG. 3, and achieves a series of print reception by the OS controlling peripheral devices (the CRT display unit 30 with a touch panel (the display unit, and touch panel), media reader/writer 40, receipt printer 50 (refer to FIG. 1), printer 60 (refer to FIG. 1), and various devices on the network) through each driver software.

The print reception service software makes print service executed by making a user operate a touch panel according to an operation screen by making the CRT display unit 30 with a touch panel display the operation screen as described later, inputting data from a peripheral device (for example, the media reader/writer 40) with sequentially switching operation screens according to the operation of the user, and executing internal processing (for example, image processing) of those data according to the operation to output the result to a peripheral device (for example, the printer 60).

The media reader/writer 40 is a reader unit for reading data from a medium, and corresponds to a medium of a portable telephone. In addition, the media reader/writer 40 may be also made to correspond to media other than a medium of a portable telephone, for example, various removable media such as a SmartMedia card, an XD picture card, a CompactFlash card, an SD card, a memory stick, and an ATA PC card, and a floppy disk.

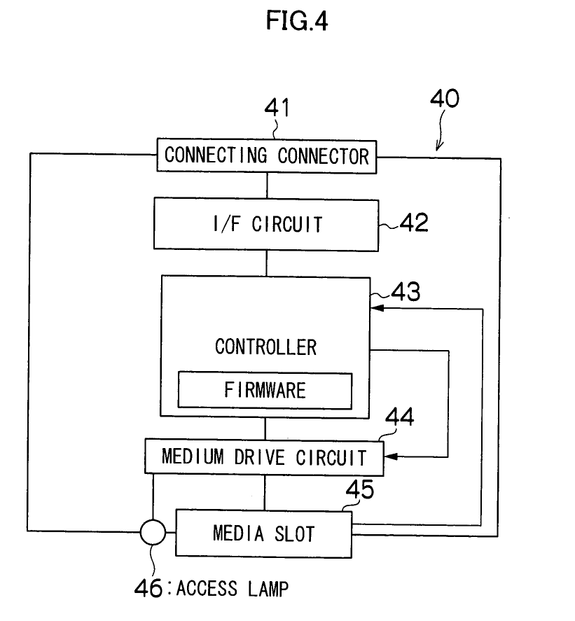

FIG. 4 is a block diagram showing a configuration example of the media reader/writer 40. As shown in this figure, the media reader/writer 40 comprises a connection connector 41, an interface (I/F) circuit 42, a controller 43 controlled by small-scale control software called firmware, a medium drive circuit 44, a media slot 45, and an access lamp 46.

The controller 43 (firmware) communicates with the driver software for the media reader/writer 40 in the main body 20, and performs the functional control of data read and the like with closely relating to the hardware of the media reader/writer 40.

In addition, the controller 43 is connected to the main body 20 through the connecting connector 41 and I/F circuit 42. Furthermore, in this embodiment, a USB I/F currently generally used in a PC is used for interface with the main body 20.

The media reader/writer 40 is controlled by the firmware installed in the controller 43. Since this firmware is written in flash memory in the controller (or, in the external), it is possible to modify a control method or to respond to a bug by rewriting the firmware by a firmware uploading function.

The controller (firmware) 43 can perform command communication with the main body 20, and can read or write data in a medium loaded in the media slot 45. In the present embodiment, although one media slot is expressed for simplification, a plurality of media slots may be provided with a print reception service machine 10 so as to correspond to various media.

The medium drive circuit 44 displays conditions of a medium with the access lamp 46 while driving the medium, which is loaded into the media slot 45, according to a control signal of the controller 43 and accessing the medium (writing and reading).

Next, an example of the print reception operation and processing which uses the print reception service machine 10 of the present invention will be explained.

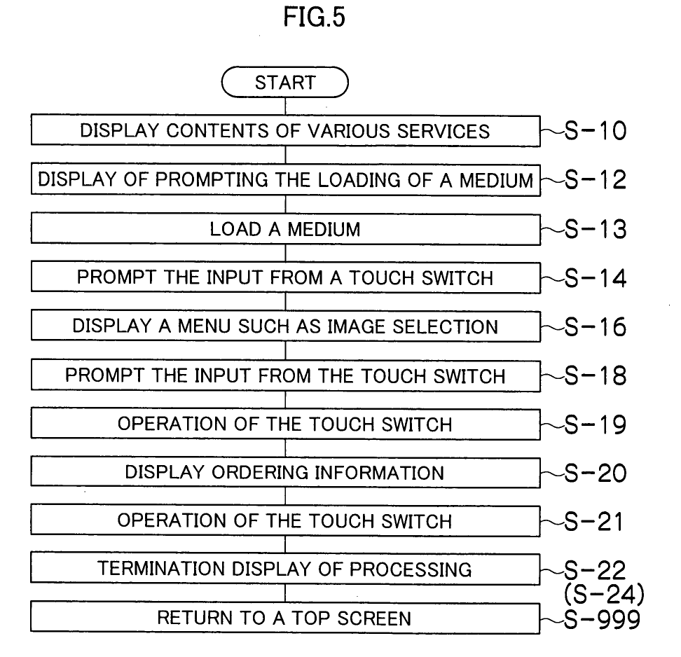

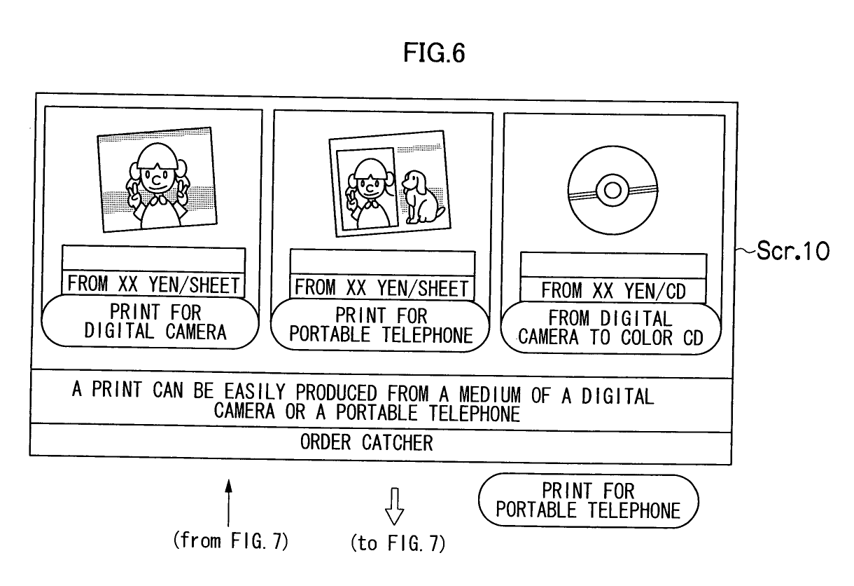

FIG. 5 is a flowchart showing an example of processing using the print reception service machine 10. This example shown in FIG. 5 is an example of a service of reading images, recorded in a medium, from the media of a portable telephone which a user brings, and receives a printing order of the images, among various services which a user can receive from the print reception service machine 10. In addition, a display screen on the CRT display unit 30 with a touch panel at each step is displayed in FIGS. 6 to 12. In FIG. 6 to FIG. 12 , Scr. 10 to Scr. 999 is a screen displayed at step S10 to step S999 shown in FIG. 5, respectively.

First, a command prompting a user to select various services is displayed on the screen of the CRT display unit 30 with a touch panel (step S10). Services displayed here are, as shown in FIG. 6 (Scr.10), 1) a service which reads images, recorded in a medium, from the medium of a DSC which a user brings, and receives a printing order of the images, 2) a service which reads images, recorded in a medium, from the medium of a portable telephone which a user brings, and receives a printing order of the images, and 3) a service which reads images, recorded in a medium, from the medium of a DSC which a user brings, and records them in a CD. Here, the service in item 2) is selected.

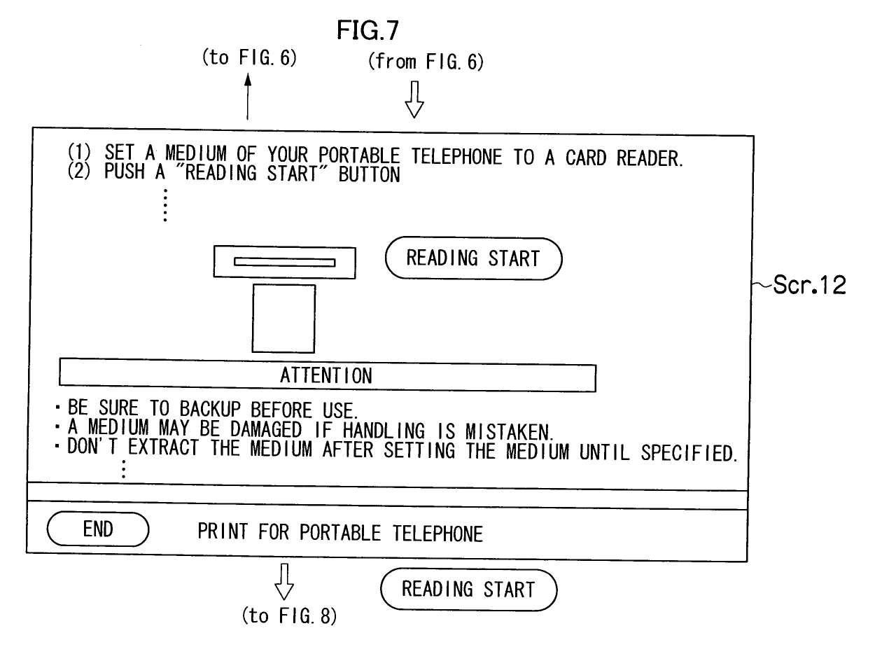

Next, the screen changes and a command, prompting a user to load a medium, on the screen of the CRT display unit 30 with a touch panel is displayed (step S 12), as shown in FIG. 7 (Scr. 12). In this case, according to the command, the user loads the medium of a portable telephone into the media slot 45 of the media reader/writer 40 (step S13).

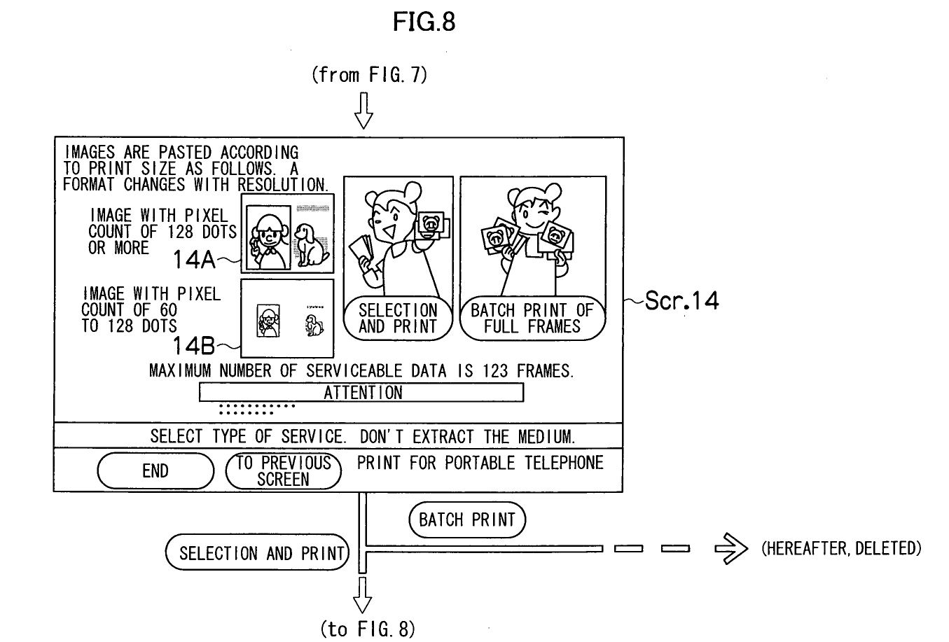

Then, as shown in FIG. 8 (Scr. 14), the screen changes, and a menu of print services is displayed on the screen and prompts the user to operate a touch switch (step S14). Contents of this menu of print services are 1) a service of making a user select images to be printed and receiving a printing order, and 2) a service of receiving a printing order that full frames should be printed in batch. Here, the service in item 1) is selected.

In addition, in the left side of the screen (Scr. 14) at this step S14, layout at the time of printing images by two images on one sheet of photo paper is previewed in a compressed mode. The upper display 14A designates a layout corresponding to images with 240×320 pixels or more, and the size in the condition that each image printed is 5.9 cm wide×7.9 cm long. The lower display 14B designates a layout corresponding to images with 120×120 pixels to under 240×320 pixels, and the size in the condition that each image printed is 3 cm wide×4 cm long.

Thus, a user can select optimum print conditions by displaying the layout at the time of printing beforehand.

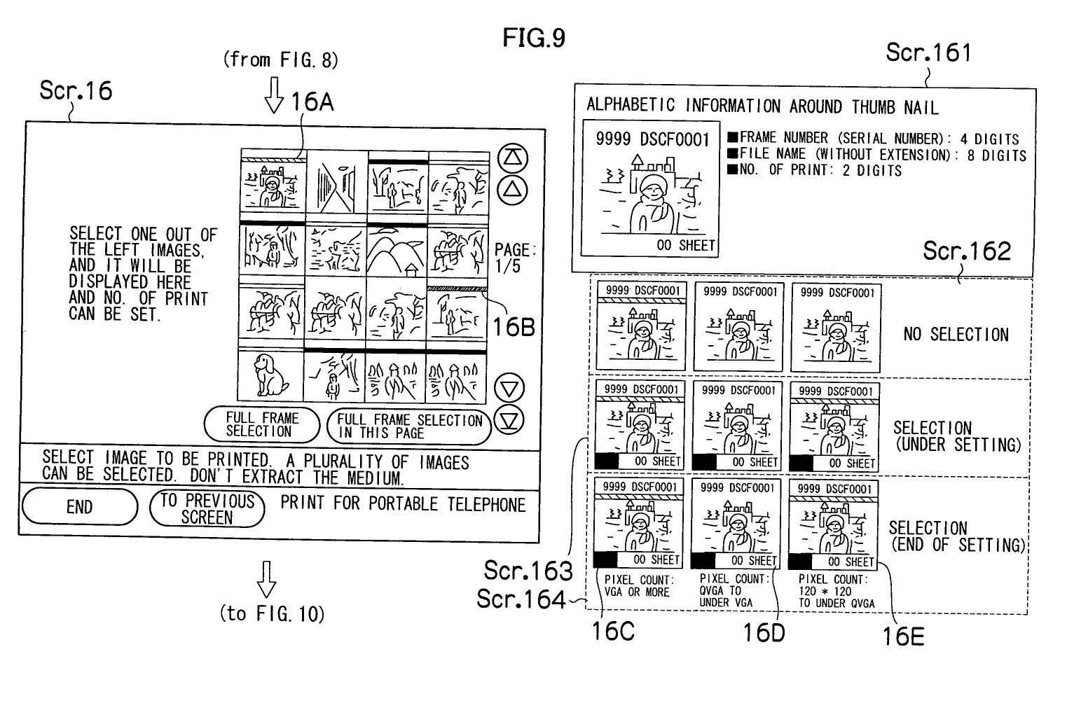

Then, the screen changes, and the menu at the time of the print service is displayed on the screen and prompts the user to operate a touch switch (step S16), as shown in FIG. 9 (Scr. 16 to Scr. 164). In Scr. 16, while displaying the images, recorded in the medium, in a thumbnail mode, display corresponding to the pixel counts of these images is given to the images which are displayed in the thumbnail mode. In addition, contents of printing at the time of printing the attached information of each image near the image printed on photo paper can be checked.

As specific means to perform the display corresponding to the pixel counts of images, as shown in FIG. 9 (Scr. 16 to Scr. 164), it is possible to adopt a method of attaching the bar indication, classified by color, to each image which is displayed in the thumbnail mode. In an example of FIG. 9, although no indication is performed to images with 240×320 pixels to under 480×640 pixels, red bar indication 16A is performed to images with 480×640 pixels or more, and yellow bar indication 16B is performed to images with 120×120 pixels to under 240×320 pixels.

Scr. 161 to Scr. 164 are explanatory diagrams of an aspect of checking the contents of printing at the time of printing the attached information of each image near the image printed on photo paper.

In Scr. 161, the alphabetic information (attached information on images) of selected images is illustrated. Scr. 162 shows preview images when alphabetic information is not printed around selected images. Scr. 163 shows preview images under selection (under setting) at the time of printing alphabetic information around selected images. In Scr. 164, various states that the alphabetic information (attached information on images) of selected images is printed are illustrated (16C to 16E). A user can select the content of the alphabetic information, which should be printed with being attached to the selected images, by operating various switches on the screen.

As for the attached information of an image, it is requested to print not only a date as conventional, but also a file name etc. in full size, to print the entire characters even in the case of a long file name or a long character string. Hence, software configuration corresponding to these is adopted.

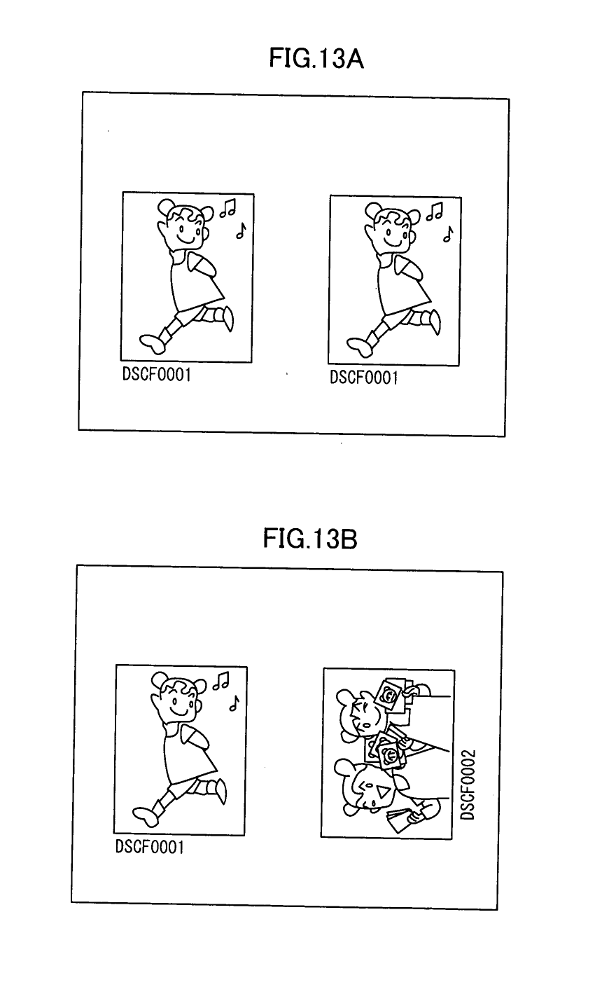

Furthermore, in addition to the function of printing the attached information of images, the print reception service machine 10 also has a function of selecting a printing location. FIG. 13A and FIG. 13B show print examples for explaining the function of selecting a printing location. Since a display screen of a normal portable telephone is longwise, it is common that a taken picture is also longwise in correspondence to this. Hence, plenty of images taken with portable telephones are longwise.

FIG. 13A shows the state of printing these two longwise images (identical images in this case) on one sheet of photo paper. It is natural to print attached information under each image in this state, and this is an aspect generally adopted.

On the other hand, an image can be taken in oblong layout with a portable telephone. For example, an image can be taken for a line of people. In this case, the portable telephone will be used for taking an image with being rotated sideways.

FIG. 13B shows an example in which such an image is included. That is, FIG. 13B shows a state that a longwise left image and an oblong right image are printed on one sheet of photo paper. Although it is natural to print attached information under the left image in this state, it is unnatural to print attached information under the right image. Then, it is made to be able to print such an oblong image in an optimum direction in an optimum location as shown in FIG. 13B by providing a function of enabling the selection of a printing location.

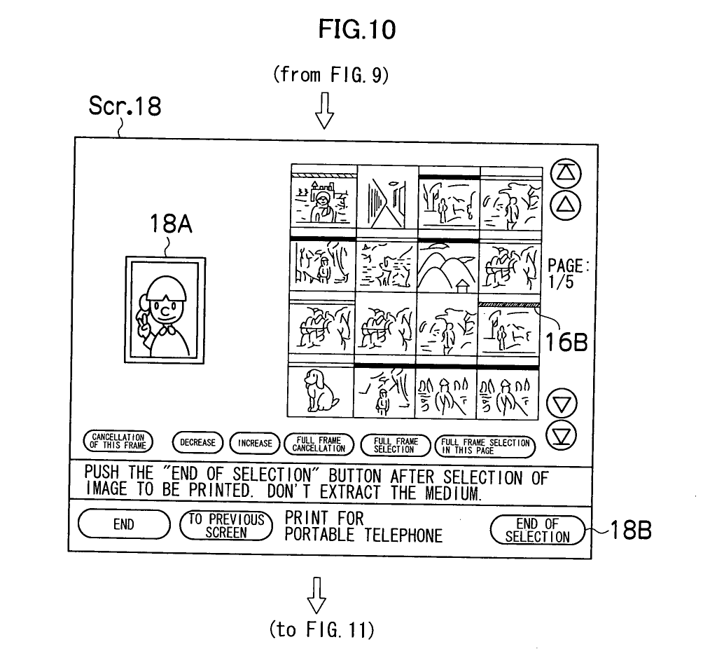

Subsequently to step S16, the screen changes, and the screen selection menu at the time of the print service is displayed on the screen and prompts the user to operate a touch switch (step S18), as shown in FIG. 10 (Scr. 18). As for thumbnail display on the screen, it is the same as that at step S16. The selected images are previewed at step S18. A preview display 18A is displayed in the state of printing two images on one sheet of photo paper, and is displayed in the size corresponding to pixel counts of images.

That is, an image of thes preview display 18A is a taken image with 240×320 pixels or more, and the size in the condition of being printed is 5.9 cm wide×7.9 cm long.

The print reception service machine 10 automatically performs the operation of making a display unit display a screen of print services suitable for a pixel count of each image with an image discrimination device etc. as this preview display 18A. However, it is also possible to provide an automatic/manual switch device so as to be able to individually perform the operation every image by a user's manual operation (operation with the touch switch).

At step S18, when the selection of images at the time of print service is ended and the touch switch 18B is operated according to a command (step S19), the process moves to the next step.

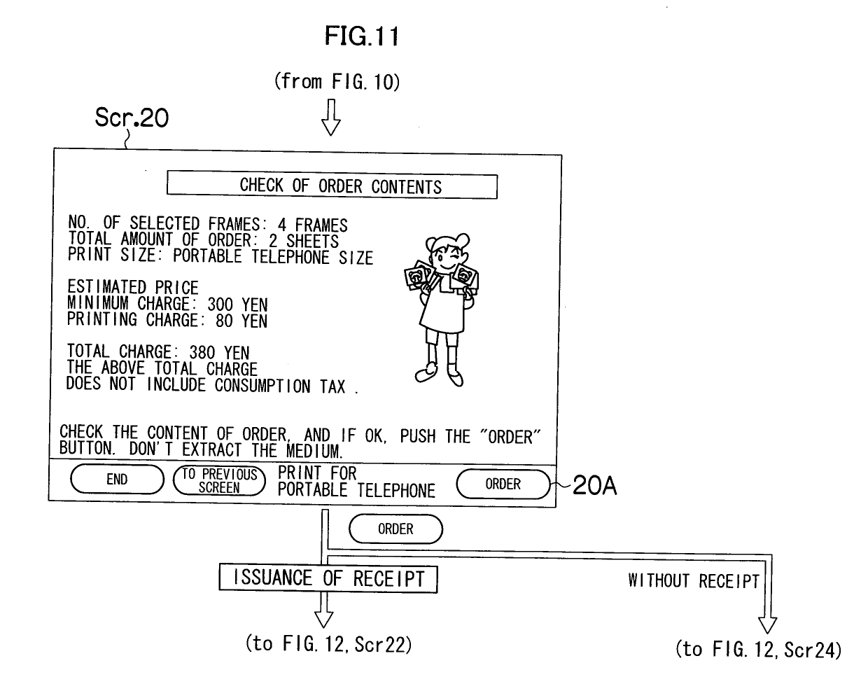

As shown in FIGS. 5 and 11, the screen changes and ordering information produced is displayed (step S20), as shown in Scr. 20. The number of selected frames, total amount of the order, print size, and estimated prices are displayed at step S20 (Scr. 20). If there is no objection in order contents and a user operates a touch switch 20A according to a command (step S21), the process moves to the next screen.

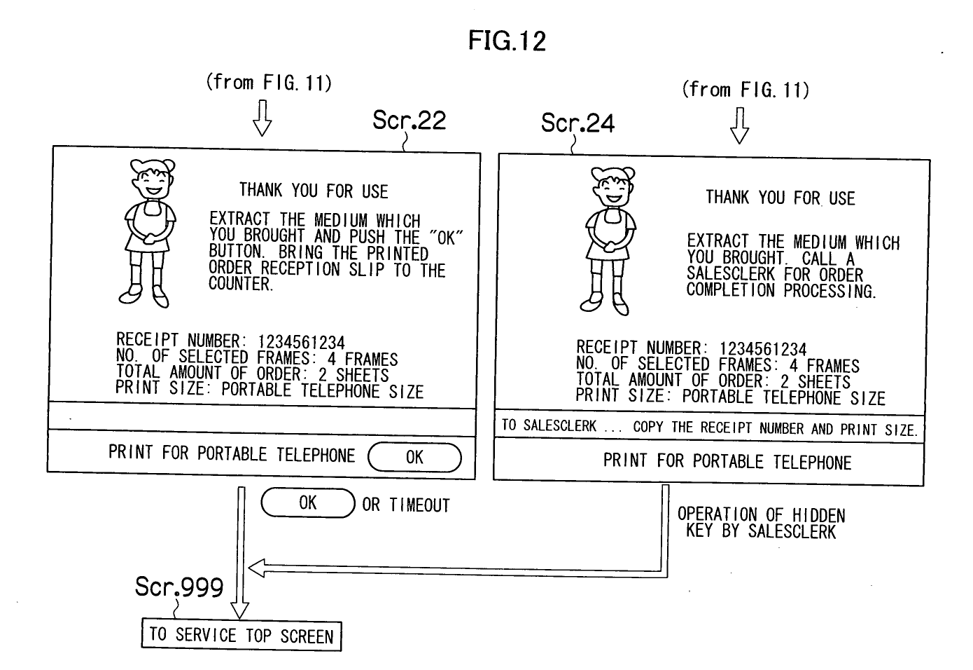

Subsequently to step S21, the process moves to step S22 or step S24 by a shop staffs selection. At step S22, a service screen for issuing a receipt is displayed as shown in FIG. 12 (Scr. 22), and at step S24, a service screen for not issuing a receipt is displayed as shown in FIG. 12 (Scr. 24).

At step S22 or step S24, power supply to the medium is stopped to make the medium ready to be ejected. The processing is ended with the screen at step S22 or step S24, and the processing returns to the service top screen (step S999, Scr. 999).

As mentioned above, although the examples of the embodiments of the print reception apparatus according to the present invention are explained, the present invention is not limited to the examples of the above-mentioned embodiments, but various kinds of aspects can be taken.

For example, although it is made that the print reception service machine 10 of the embodiment prints two images with 5.9 cm wide×7.9 cm long or 3 cm wide×4 cm long on one sheet of photo paper with normal size (L size), it is also preferable to make it print images with the sizes other than the normal size, for example, 5.5 cm wide×8.9 cm long.

In addition, although the bar indication classified by color is adopted as specific means to perform the indication, corresponding to the pixel count of an image, in the example of the embodiment, it is also preferable to adopt various indication methods other than the bar indication.

What is claimed is:

1. A print reception apparatus which is installed in a shop front or inside of a shop, reads images recorded in a medium of a portable telephone which a user brings, and accepts a printing order of the images, comprising:
a medium reader which the medium is detached from and attached to;
a display device which displays a screen for prompting operation and verification of a user at the time of a printing order;
an operation device which a user operating with looking at a screen displayed on the display device; and
a control device which makes the display device switch and display a screen on the basis of detaching or attaching operation of the medium to or from the media reader and operation with the operation device, and generates ordering information while capturing images used for printing from the medium which is loaded in the media reader,
wherein the control device controls a printer so as to print the captured images by two images on one sheet of photo paper.

2. A print reception apparatus which is installed in a shop front or inside of a shop, reads images recorded in a medium of a portable telephone which a user brings, and accepts a printing order of the images, comprising:
a medium reader which the medium is detached from and attached to;
a display device which displays a screen for prompting operation and verification of a user at the time of a printing order;
an operation device which a user operating with looking at a screen displayed on the display device; and
a control device which makes the display device switch and display a screen on the basis of detaching or attaching operation of the medium to or from the media reader and operation with the operation device, and generates ordering information while capturing images used for printing from the medium which is mounted on the media reader,
wherein the control device controls a printer so as to print the captured images by four images on one sheet of photo paper.

3. The print reception apparatus according to claim 1, wherein the control device comprises an image discrimination device discriminating pixel counts of the captured images while capturing the images, used for printing, from the medium which is loaded in the media reader; and
wherein the control device makes the display device display a screen of print services suitable for a pixel count of each of the images.

4. The print reception apparatus according to claim 1, wherein the control device controls a printer so as to print attached information of an image near the image printed on a photo paper while capturing the attached information of the image, used for printing, from a medium which is loaded in the media reader.

5. The print reception apparatus according to claim 3, wherein the control device gives display, corresponding to a pixel count of an image to the image, which is displayed in a thumbnail mode, while making the display device display the captured image in the thumbnail mode.
